(19) United States
(12) Patent Application Publication
(10) Pub. No.: US 2026/0142419 A1
(43) Pub. Date: May 21, 2026

(54) CONNECTOR

(71) Applicant: SUMITOMO WIRING SYSTEMS, LTD., Mie (JP)

(72) Inventor: Yoichi TAKAGI, Mie (JP)

(21) Appl. No.: 19/117,408

(22) PCT Filed: Oct. 6, 2023
(86) PCT No.: PCT/JP2023/036508

§ 371 Date: Apr. 1, 2025

(30) Foreign Application Priority Data
Oct. 7, 2022 (JP) 2022-162118

(51) Int. Cl. H01R 13/641; H01R 13/631

(52) U.S. Cl. CPC H01R 13/641; H01R 13/631

(57) ABSTRACT

A connector includes a housing connectable to a mating housing and a connection detecting member allowed to move from a temporary locking position to a complete locking position with the housing and the mating housing properly connected. The housing includes a lock arm cantilevered and formed to be deflectable and deformable. The lock arm includes a lock portion lockable to the mating housing and a pair of arm portions disposed on both sides of the lock portion and extending from the lock portion to a free end side of the lock arm. Each of the pair of arm portions includes a lock receiving portion. The connection detecting member includes a detection arm. The detection arm includes a stopper disposed on a tip part of the detection arm and two lock protrusions disposed on both sides of the stopper.

### TECHNICAL FIELD

The present disclosure relates to a connector.

### BACKGROUND

Conventionally, a connector described in Japanese Unexamined Patent Publication No. 2020-072013 (Patent Document 1 below) is known. This connector is provided with a housing and a connection guarantee component to be mounted into the housing. The housing is provided with a lock portion to be locked to a mating housing. The lock portion is provided with a pair of lock arms, an operating portion coupling tip parts of the pair of lock arms in a width direction and an engaging portion coupling intermediate parts in a front-rear direction of the pair of lock arms in the width direction. The connection guarantee component is provided with a base portion and a detection arm extending forward from the base portion. An engaging portion is provided on the tip of the detection arm.

The connection guarantee component is held at a temporary locking position and a complete locking position, at which the connection guarantee component is movable with the housing and the mating housing connected, in the housing. At the temporary locking position, the engaging portion of the detection arm and the engaging portion of the lock portion are locked, whereby the connection guarantee component cannot be moved to the complete locking position by being pushed forward. If the housing and the mating housing are connected, a mating lock portion of the mating housing pushes the engaging portion of the detection arm downward, whereby the locking of the engaging portion of the detection arm and the engaging portion of the lock portion is released. In this way, the connection guarantee component can be moved to the complete locking position.

### PRIOR ART DOCUMENT

### Patent Document

Patent Document 1: JP 2020-072013 A

### SUMMARY OF THE INVENTION

### Problems to be Solved

However, in the case of adopting the above configuration for a small-size connector, areas of locking surfaces of the engaging portion of the detection arm and the engaging portion of the lock portion may become smaller. If the areas of these locking surfaces are small, the lock arms and the detection arm may be deflected with a relatively small force and the connection guarantee component may be pushed to the complete locking position even if the housing and the mating housing are not completely connected. Therefore, connection detection by the connection guarantee component may not be properly carried out.

### Means to Solve the Problem

The present disclosure is directed to a connector with a housing connectable to a mating housing and a connection detecting member movable between a temporary locking position and a complete locking position with respect to the housing, the connection detecting member being allowed to move from the temporary locking position to the complete locking position with the housing and the mating housing properly connected, the housing including a lock arm cantilevered from an outer peripheral wall of the housing, the lock arm being formed to be deflectable and deformable, the lock arm including a lock portion lockable to the mating housing, a pair of arm portions disposed on both sides of the lock portion, the pair of arm portions extending from the lock portion to a free end side of the lock arm, and an operating portion coupling the pair of arm portions, each of the pair of arm portions including a lock receiving portion, the connection detecting member including a body portion and a detection arm extending from the body portion, the detection arm including a stopper disposed on a tip part of the detection arm and two lock protrusions disposed on both sides of the stopper, and a movement of the connection detecting member from the temporary locking position to the complete locking position being suppressed by locking the stopper to the lock portion and locking the lock protrusions to the lock receiving portions.

### EFFECT OF THE INVENTION

According to the present disclosure, it is possible to provide a connector capable of suppressing a movement of a connection detecting member to a complete locking position in a state where the connector is not properly connected.

### BRIEF DESCRIPTION OF THE DRAWINGS

FIG. 1 is an exploded perspective view of a connector according to an embodiment.

FIG. 2 is a plan view of the connector having a connection detecting member held at a temporary locking position.

FIG. 3 is a section along A-A of FIG. 2.

FIG. 4 is a section along B-B of FIG. 2.

FIG. 5 is a section along C-C of FIG. 2.

FIG. 6 is an enlarged view of FIG. 4 showing the periphery of a lock receiving portion and a lock protrusion.

FIG. 7 is a diagram showing a state where a housing and a mating housing are properly connected in a cross-section along A-A of FIG. 2.

FIG. 8 is a diagram showing the state where the housing and the mating housing are properly connected in a cross-section along B-B of FIG. 2.

FIG. 9 is a diagram showing a state where the connection detecting member is held at a complete locking position in the cross-section along A-A of FIG. 2.

FIG. 10 is a diagram showing the state where the connection detecting member is held at the complete locking position in the cross-section along B-B of FIG. 2.

FIG. 11 is a section along D-D of FIG. 4.

FIG. 12 is a perspective view showing a tip part of a detection arm.

### DETAILED DESCRIPTION TO EXECUTE THE INVENTION

### Description of Embodiments of Present Disclosure

First, embodiments of the present disclosure are listed and described.

(1) The connector of the present disclosure is provided with a housing connectable to a mating housing and a connection detecting member movable between a temporary locking position and a complete locking position with respect to the housing, the connection detecting member being allowed to move from the temporary locking position to the complete locking position with the housing and the mating housing properly connected, the housing including a lock arm cantilevered from an outer peripheral wall of the housing, the lock arm being formed to be deflectable and deformable, the lock arm including a lock portion lockable to the mating housing, a pair of arm portions disposed on both sides of the lock portion, the pair of arm portions extending from the lock portion to a free end side of the lock arm, and an operating portion coupling the pair of arm portions, each of the pair of arm portions including a lock receiving portion, the connection detecting member including a body portion and a detection arm extending from the body portion, the detection arm including a stopper disposed on a tip part of the detection arm and two lock protrusions disposed on both sides of the stopper, and a movement of the connection detecting member from the temporary locking position to the complete locking position being suppressed by locking the stopper to the lock portion and locking the lock protrusions to the lock receiving portions.

According to this configuration, since not only the stopper and the lock portion are locked, but also the lock protrusions and the lock receiving portions are locked with the connection detecting member located at the temporary locking position, locking surfaces of the connection detecting member and the housing can be made larger. Thus, a movement of the connection detecting member to the complete locking position can be suppressed in a state where the connector is not properly connected.

(2) Preferably, the lock receiving portion includes a contact portion and a ceiling portion connected to the contact portion, the ceiling portion being formed in a range from the contact portion to the operating portion in a connection direction of the housing and the mating housing, the complete locking position is located on one side in the connection direction with respect to the temporary locking position, and the ceiling portion is facing the lock protrusion in a deflection direction of the lock arm orthogonal to the connection direction and the contact portion is disposed to be lockable to the lock protrusion in the connection direction when the connection detecting member is pushed to the one side in the connection direction with the connection detecting member located at the temporary locking position.

According to this configuration, since the ceiling portion is formed in the range from the contact portion to the operating portion in the connection direction, the thinning of the pair of arm portions associated with the formation of the lock receiving portions can be suppressed to a minimum level. Thus, it can be suppressed that only the pair of arm portions are excessively deflected due to insufficient strength caused by thinning when the operating portion is pressed to deflect the lock arm. Therefore, the locking of the lock portion and the mating lock portion can be properly released by the operating portion.

(3) Preferably, the contact portion is inclined in a direction separating from the outer peripheral wall with respect to the deflection direction toward the one side in the connection direction.

According to this configuration, if an attempt is made to move the connection detecting member to the complete locking position with the connection detecting member located at the temporary locking position, the lock protrusions contact or slide in contact with the contact portions, whereby the locking of the lock protrusions and the lock receiving portions is hardly released. Thus, a movement of the connection detecting member to the complete locking position can be further suppressed in the state where the connector is not properly connected.

### Details of Embodiment of Present Disclosure

Hereinafter, an embodiment of the present disclosure is described. The present disclosure is not limited to these illustrations, but is represented by claims and intended to include all changes in the scope of claims and in the meaning and scope of equivalents.

### Embodiment

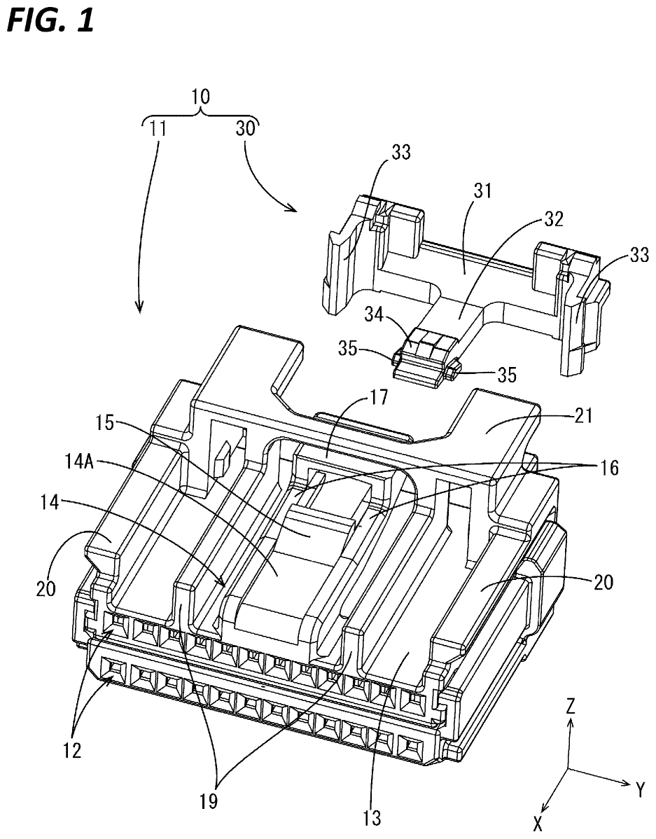

The embodiment of the present disclosure is described with reference to FIGS. 1 to 12. In the following description, a direction indicated by an arrow Z is referred to as an upward direction, a direction indicated by an arrow X is referred to as a forward direction and a direction indicated by an arrow Y is referred to as a leftward direction. Note that, for a plurality of identical members, only some members may be denoted by a reference sign and the other members may not be denoted by the reference sign.

### Connector

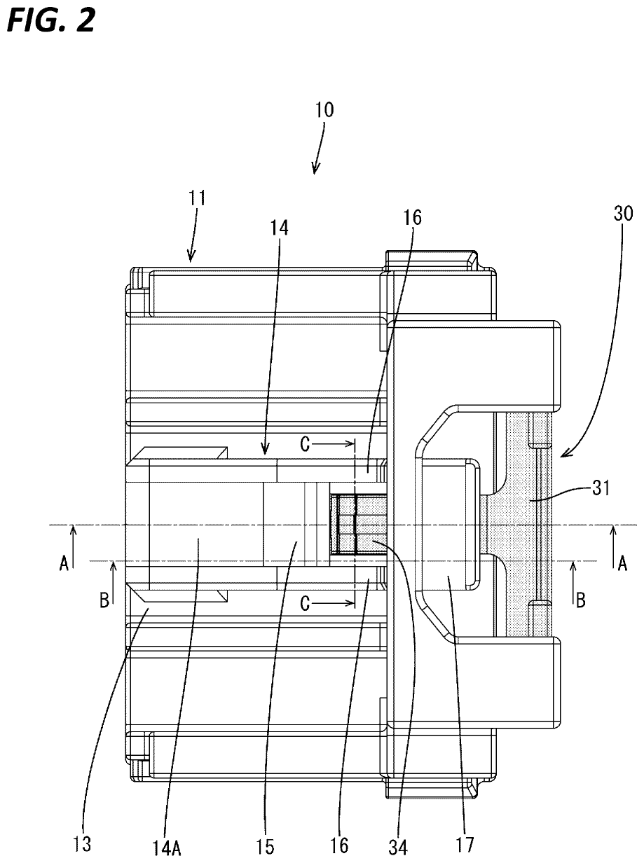

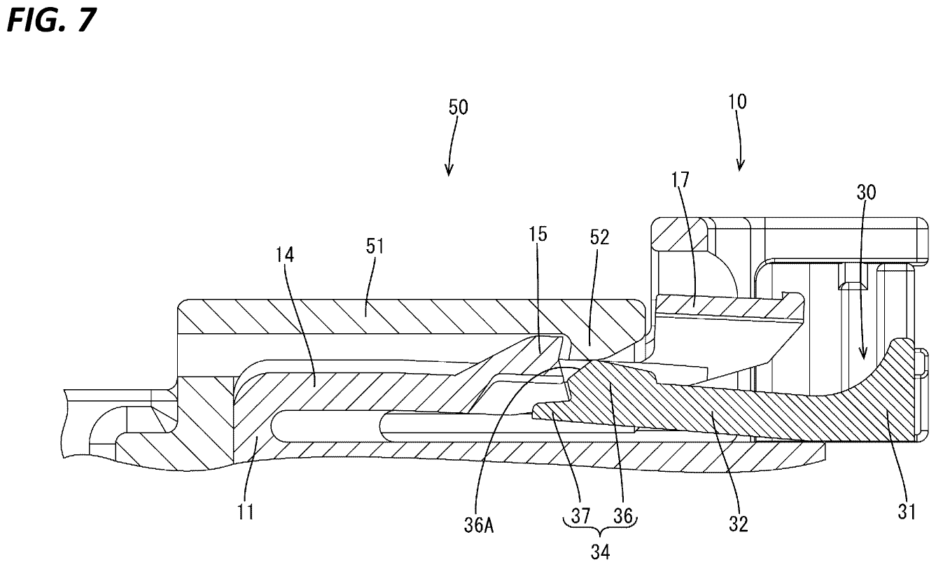

As shown in FIGS. 1 and 2, a connector 10 of this embodiment is provided with a housing 11 and a connection detecting member 30 to be assembled with the housing 11. As shown in FIG. 7, a connection partner of the connector 10 is a mating connector 50 provided with a mating housing 51. The housing 11 and the mating housing 51 are connected in a front-rear direction (an example of a connection direction).

### Mating Housing

The mating connector 50 is provided with the mating housing 51 and mating terminals (not shown) to be accommodated into the mating housing 51. The mating housing 51 is provided with a mating lock portion 52. As described later, the mating lock portion 52 is locked to a lock portion 15 of the housing 11 (see FIG. 7). In this embodiment, the mating terminals are tab-shaped male terminals.

### Housing

The housing 11 is made of insulating synthetic resin and substantially in the form of a block. As shown in FIG. 1, the housing 11 includes cavities 12 penetrating in the front-rear direction. Unillustrated terminals are accommodated in the cavities 12. These terminals are female terminals in this embodiment.

### Lock Arm

An upper wall portion of the housing 11 is an outer peripheral wall 13. The outer peripheral wall 13 is formed with a lock arm 14. The lock arm 14 is formed to be elongated in the front-rear direction as a whole. The lock arm 14 is in the form of a cantilever extending rearward from a front end part of the outer peripheral wall 13. The lock arm 14 is deflectable and deformable in a vertical direction (an example of a deflection direction) with a front end part substantially as a fulcrum.

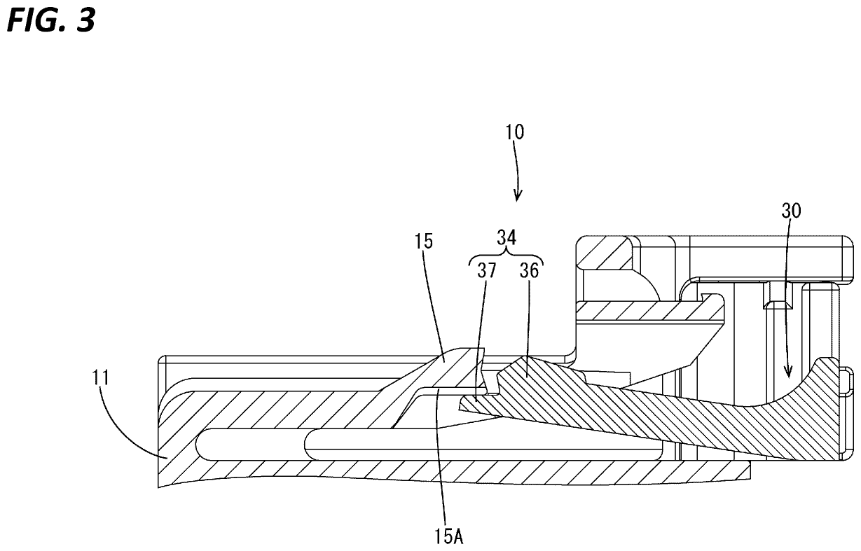

The lock arm 14 is provided with a front half 14A, the lock portion 15 projecting upward from the front half 14A, a pair of left and right arm portions 16 extending from the front half 14A to a free end side (rear side) and an operating portion 17 coupling to bridge rear end parts of the pair of arm portions 16. The front half 14A is substantially plate-like. A front end part of the front half 14A is a base end part of the lock arm 14 and connected to the outer peripheral wall 13. The lock portion 15 is disposed in a lateral central part of a rear part of the front half 14A. As shown in FIG. 3, a lock recess 15A recessed upward from the lower surface of the lock arm 14 is formed below the lock portion 15.

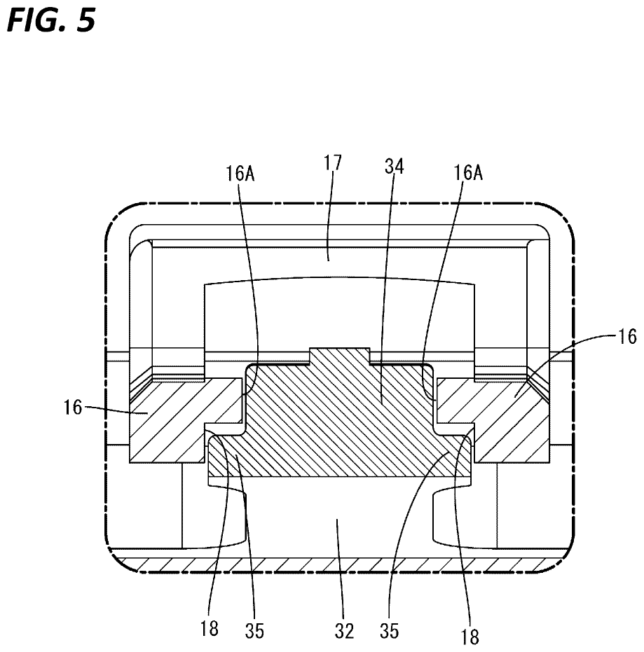

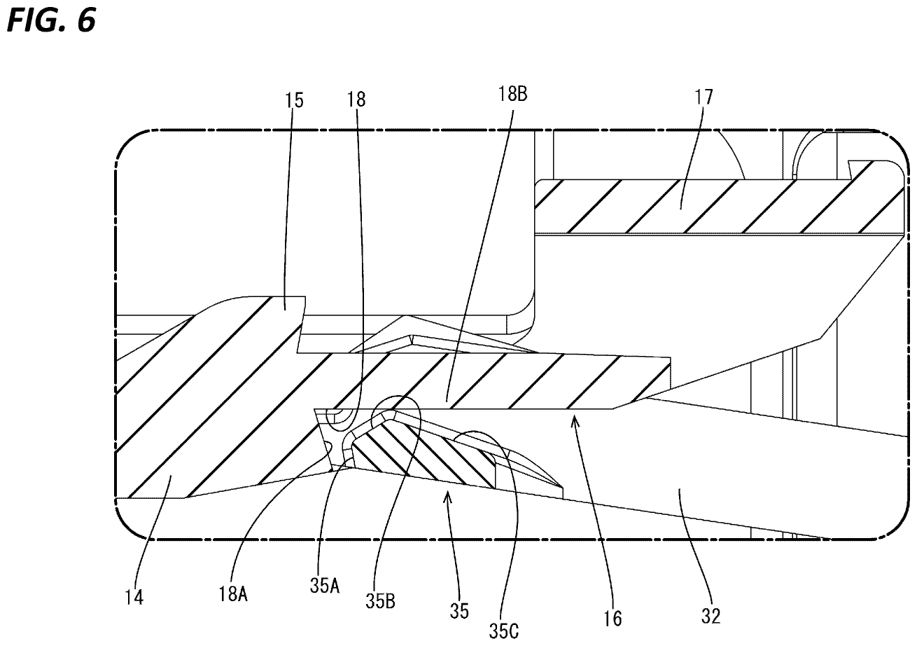

As shown in FIG. 5, the pair of arm portions 16 have facing surfaces 16A facing each other in a width direction (lateral direction) of the connector 10. In particular, the left side surface of the arm portion 16 disposed on a right side is the facing surface 16A. The right side surface of the arm portion 16 disposed on a left side is the facing surface 16A. Each arm portion 16 includes a lock receiving portion 18 recessed outward in the width direction from the facing surface 16A. The lock receiving portion 18 is recessed upward from the lower surface of each arm portion 16. As shown in FIG. 6, the lock receiving portion 18 includes a contact portion 18A intersecting an axis extending in the front-rear direction and a ceiling portion 18B connected to an upper end part of the contact portion 18A and extending in the front-rear direction. The contact portion 18A is so inclined that an upper part is located on the side of a fitting surface.

As shown in FIG. 1, the housing 11 is provided with a pair of protective walls 19 disposed on both sides of the lock arm 14 and rising upward from the outer peripheral wall 13. The entrance of an external matter between the lock arm 14 and the outer peripheral wall 13 can be suppressed by the pair of protective walls 19. Further, the housing 11 is provided with a pair of side wall portions 20 rising upward from both end parts in the width direction of the outer peripheral wall 13. Upper end parts of the pair of side wall portions 20 and those of the pair of protective walls 19 are coupled by a coupling portion 21.

### Connection Detecting Member

The connection detecting member 30 is made of insulating synthetic resin. The connection detecting member 30 is provided with a body portion 31 and a detection arm 32 extending from the body portion 31. The body portion 31 is a part to be brought into sliding contact with the outer peripheral wall 13 of the housing 11 and shaped to be long in the width direction. The detection arm 32 extends obliquely to an upper front side from a lateral center position of a front end part of the body portion 31. The detection arm 32 is deflectable and deformable with respect to the body portion 31.

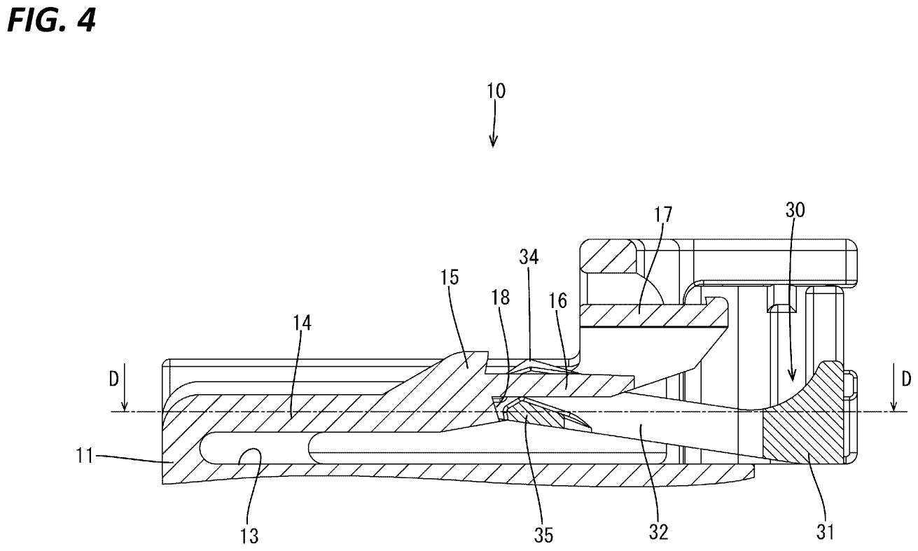

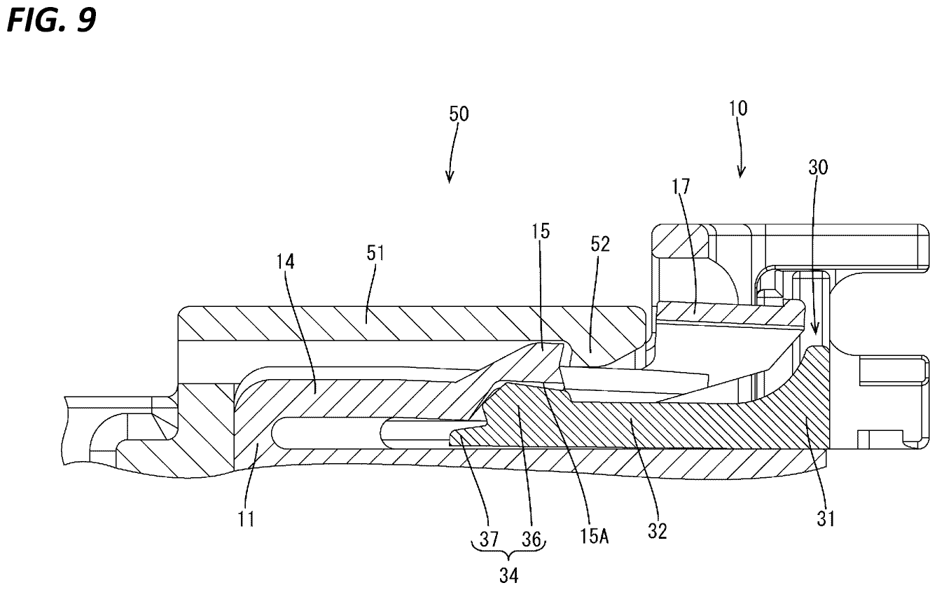

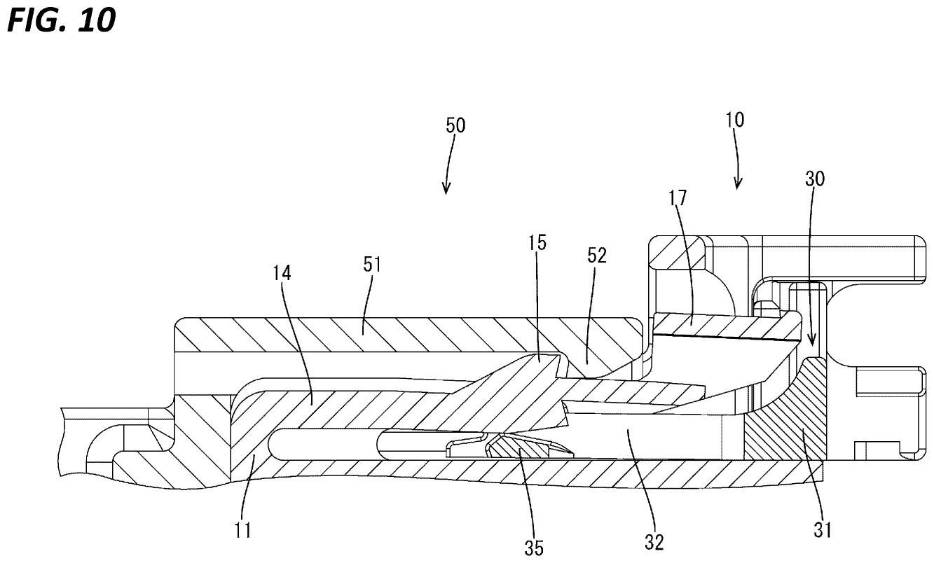

The connection detecting member 30 is provided with a pair of locking pieces 33 extending forward from both end parts in the width direction of the body portion 31. The pair of locking pieces 33 are respectively inserted between the side wall portions 20 and the protective walls 19 of the housing 11. A plurality of locking structures lockable to each other are provided between the connection detecting member 30 and the housing 11. By the plurality of these locking structures, the connection detecting member 30 is held at a temporary locking position (FIGS. 3 and 4) and a complete locking position (FIGS. 9 and 10) disposed forward of the temporary locking position with respect to the housing 11.

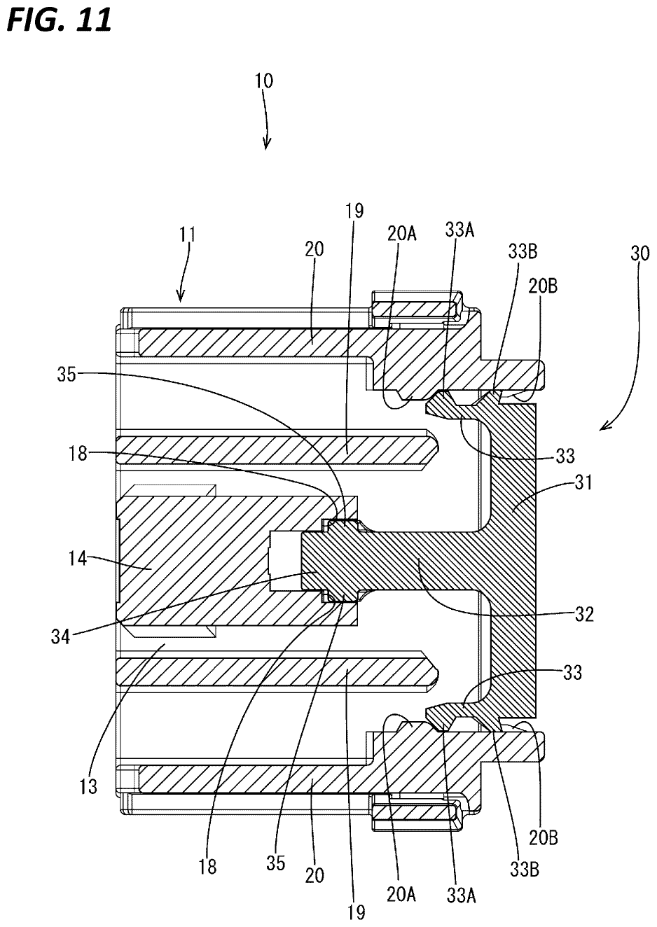

An example of the plurality of locking structures described above is shown in FIG. 11. The locking piece 33 includes a first locking projection 33A and a second locking projection 33B disposed rearward of the first locking projection 33A. The first and second locking projections 33A, 33B project outward in the width direction from the locking piece 33. The side wall portion 20 includes a third locking projection 20A and a fourth locking projection 20B disposed rearward of the third locking projection 20A. The third and fourth locking projections 20A, 20B project inward in the width direction from a rear side part of the side wall portion 20. In FIG. 11, the connection detecting member 30 is at the temporary locking position. A forward movement of the connection detecting member 30 is restricted by locking the front end surfaces of the first locking projections 33A and the rear end surfaces of the third locking projections 20A. A rearward movement of the connection detecting member 30 is restricted by locking the rear end surfaces of the second locking projections 33B and the front end surfaces of the fourth locking projections 20B. Thus, the connection detecting member 30 is held at the temporary locking position.

Further, although not shown in detail, a rearward movement of the connection detecting member 30 is restricted by locking the rear end surfaces of the first locking projections 33A and the front end surfaces of the third locking projections 20A if the connection detecting member 30 is at the complete locking position. A forward movement of the connection detecting member 30 is restricted by locking the front end of the body portion 31 and the rear ends of the protective walls 19. Thus, the connection detecting member 30 is held at the complete locking position.

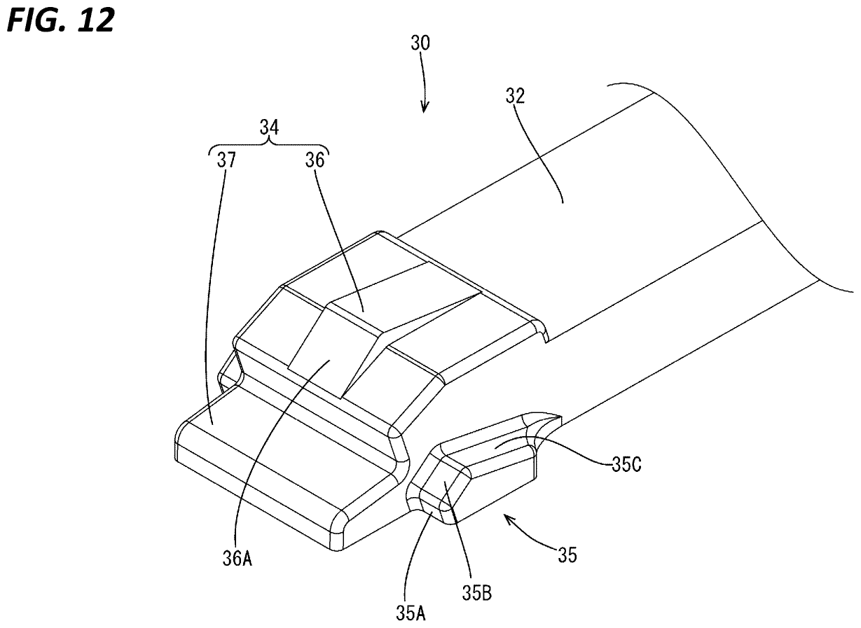

As shown in FIG. 1, the detection arm 32 includes a stopper 34 disposed on a tip part of the detection arm 32 and two lock protrusions 35 disposed on both sides of the stopper 34. As shown in FIG. 12, the stopper 34 includes a projecting portion 36 having a chevron shape and projecting upward with respect to the detection arm 32 and a projection 37 extending forward from the projecting portion 36. The projecting portion 36 has an inclined surface 36A inclined downward toward the front. The lock protrusion 35 has a first surface 35A, a second surface 35B and a third surface 35C connected to a side surface of the stopper 34. As shown in FIG. 6, the first surface 35A is so inclined that an upper part is located on the side of the fitting surface. The second surface 35B is connected to the upper end of the first surface 35A and so inclined that a lower part is located on the side of the fitting surface. The third surface 35C is connected to the rear end of the first surface 35A and so inclined that an upper part is located on the side of the fitting surface.

With the connection detecting member 30 held at the temporary locking position, the stopper 34 and the lock portion 15 are disposed to face each other in the connection direction as shown in FIG. 3. In particular, the projecting portion 36 of the stopper 34 and the lock portion 15 are facing each other in the front-rear direction, and the projection 37 of the stopper 34 is accommodated in the lock recess 15A. If an attempt is made to forcibly move the connection detecting member 30 forward in a state where the connection detecting member 30 is held at the temporary locking position and the housing 11 and the mating housing 51 are not completely connected, the projecting portion 36 of the stopper 34 and the lock portion 15 are locked. Thus, a movement of the connection detecting member 30 from the temporary locking position to the complete locking position is suppressed.

Further, with the connection detecting member 30 held at the temporary locking position, the lock receiving portion 18 has received the lock protrusion 35 as shown in FIG. 4. In particular, as shown in FIG. 6, the contact portion 18A of the lock receiving portion 18 is facing the first surface 35A of the lock protrusion 35 in the connection direction. The ceiling portion 18B of the lock receiving portion 18 is disposed above the lock protrusion 35. If an attempt is made to forcibly move the connection detecting member 30 forward in the state where the connection detecting member 30 is held at the temporary locking position and the housing 11 and the mating housing 51 are not completely connected, the contact portions 18A and the first surfaces 35A of the lock protrusions 35 are locked. Thus, a movement of the connection detecting member 30 from the temporary locking position to the complete locking position is suppressed.

In this embodiment, the contact portion 18A is so inclined that the upper part is located on the side of the fitting surface. Thus, if an attempt is made to move the connection detecting member 30 forward in the state shown in FIG. 6, the contact portion 18A and the first surface 35A of the lock protrusion 35 contact or slide in contact and the lock protrusion 35 moves to the back of the lock receiving portion 18 (to above the contact portion 18A). Thus, the lock protrusion 35 does not slip under the lock arm 14, wherefore the locking of the lock receiving portion 18 and the lock protrusion 35 is hardly released.

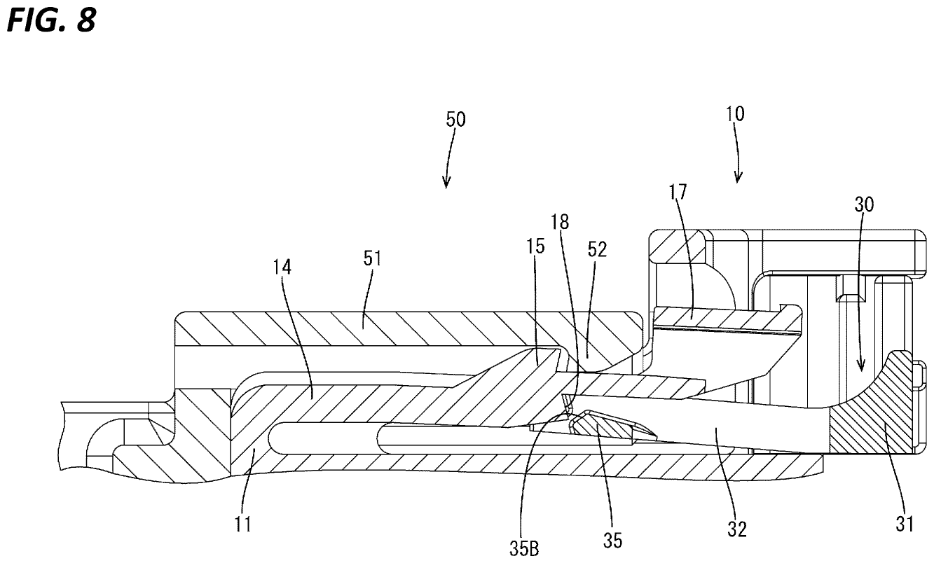

With the connection of the housing 11 and the mating housing 51 completed (properly connected state), the mating lock portion 52 and the lock portion 15 are locked as shown in FIG. 7. Further, with the connection detecting member 30 held at the temporary locking position, the mating lock portion 52 pushes the stopper 34 downward. If the connection detecting member 30 is pushed forward with the housing 11 and the mating housing 51 properly connected, the inclined surface 36A of the projecting portion 36 of the stopper 34 slides in contact with the lock portion 15. Further, the second surface 35B of the lock protrusion 35 slides in contact with a lower end part of the lock receiving portion 18 (see FIG. 8). In this way, the detection arm 32 moves forward while being deflected further downward and the connection detecting member 30 reaches the complete locking position (see FIGS. 9 and 10). If the connection detecting member 30 is pushed to the complete locking position, the proper connection of the housing 11 and the mating housing 51 is detected.

With the connection detecting member 30 held at the complete locking position, the projecting portion 36 of the stopper 34 is accommodated in the lock recess 15A as shown in FIG. 9. Further, as shown in FIG. 10, the lock protrusion 35 is disposed below the lock arm 14.

To separate the housing 11 from the mating housing 51, the connection detecting member 30 is first moved from the complete locking position to the temporary locking position (see FIGS. 7 and 8). Thereafter, by pressing the operating portion 17, the lock arm 14 is deflected downward to release the locking of the lock portion 15 and the mating lock portion 52. Then, the housing 11 and the mating housing 51 are separated by being spaced apart from each other in the front-rear direction.

### Concerning Locking of Detection Arm and Lock Arm

If the width of the connector 10 is small, locking surfaces of the stopper 34 and the lock portion 15 become smaller (see FIG. 2). Thus, it may be difficult to suppress a forward movement of the connection detecting member 30 from the temporary locking position in a state where the connector 10 is not properly connected. To ensure sufficiently large locking surfaces of the stopper 34 and the lock portion 15, it is thought to enlarge the stopper 34 in the width direction and make the pair of arm portions 16 of the lock arm 14 smaller in the width direction. However, if the pair of arm portions 16 are made smaller in the width direction to be thinned, there is a possibility that only the pair of arm portions 16, out of the lock arm 14, are largely deflected and the front half 14A is hardly deflected when the operating portion 17 is pressed. This leads to a possibility that the locking of the lock portion 15 of the housing 11 and the mating lock portion 52 of the mating housing 51 cannot be released.

Accordingly, in this embodiment, the lock receiving portions 18 are provided by partially cutting the pair of arm portions 16 and the lock protrusions 35 are provided on the both sides of the stopper 34 (see FIG. 4). In this way, even if the width of the connector 10 is small, the locking surfaces of the detection arm 32 and the lock arm 14 can be made larger while the thinning of the pair of arm portions 16 is suppressed. Therefore, the locking of the lock portion 15 of the housing 11 and the mating lock portion 52 of the mating housing 51 can be properly released and a forward movement of the connection detecting member 30 from the temporary locking position can be suppressed in the state where the connector 10 is not properly connected.

Further, since the ceiling portions 18B extend in the front-rear direction from the contact portions 18A to the operating portion 17 in this embodiment, the thinning of the pair of arm portions 16 is further suppressed (see FIG. 6).

### Functions and Effects of Embodiment

According to the embodiment, the following functions and effects are achieved.

The connector 10 according to the embodiment is provided with the housing 11 connectable to the mating housing 51 and the connection detecting member 30 movable between the temporary locking position and the complete locking position with respect to the housing 11 and allowed to move from the temporary locking position to the complete locking position with the housing 11 and the mating housing 51 properly connected. The housing 11 includes the lock arm 14 cantilevered from the outer peripheral wall 13 of the housing 11 and formed to be deflectable and deformable. The lock arm 14 includes the lock portion 15 lockable to the mating housing 51, the pair of arm portions 16 disposed on the both sides of the lock portion 15 and extending from the lock portion 15 to the free end side of the lock arm 14 and the operating portion 17 coupling the pair of arm portions 16. Each of the pair of arm portions 16 includes the lock receiving portion 18. The connection detecting member 30 includes the body portion 31 and the detection arm 32 extending from the body portion 31. The detection arm 32 includes the stopper 34 disposed on the tip part of the detection arm 32 and the two lock protrusions 35 disposed on the both sides of the stopper 34. A movement of the connection detecting member from the temporary locking position to the complete locking position is suppressed by locking the stopper 34 to the lock portion 15 and locking the lock protrusions 35 to the lock receiving portions 18.

According to this configuration, with the connection detecting member 30 located at the temporary locking position, not only the stopper 34 and the lock portion 15 are locked, but also the lock protrusions 35 and the lock receiving portions 18 are locked. Thus, the locking surfaces of the connection detecting member 30 and the housing 11 can be made larger. Thus, a movement of the connection detecting member 30 to the complete locking position can be suppressed in the state where the connector 10 is not properly connected.

In this embodiment, the lock receiving portion 18 includes the contact portion 18A and the ceiling portion 18B connected to the contact portion 18A and formed in a range from the contact portion 18A to the operating portion 17 in the connection direction (front-rear direction) of the housing 11 and the mating housing 51. The complete locking position is located on one side (front side) in the connection direction with respect to the temporary locking position. With the connection detecting member 30 held at the temporary locking position, the ceiling portion 18B is facing the lock protrusion 35 in the deflection direction (vertical direction) of the lock arm 14 orthogonal to the connection direction. The contact portion 18A is disposed to be lockable to the lock protrusion 35 in the connection direction when the connection detecting member 30 is pushed to the one side in the connection direction.

According to this configuration, since the ceiling portion 18B is formed in the range from the contact portion 18A to the operating portion 17 in the connection direction, the thinning of the pair of arm portions 16 associated with the formation of the lock receiving portions 18 can be suppressed to a minimum level. Thus, it can be suppressed that only the pair of arm portions 16 are excessively deflected due to insufficient strength caused by thinning when the operating portion 17 is pressed to deflect the lock arm 14. Therefore, the locking of the lock portion 15 and the mating lock portion 51 can be properly released by the operating portion 17.

In the embodiment, the contact portion 18A is inclined in the direction separating from the outer peripheral wall 13 (upward) with respect to the deflection direction toward the one side in the connection direction.

According to this configuration, if an attempt is made to move the connection detecting member 30 to the complete locking position with the connection detecting member 30 located at the temporary locking position, the lock protrusions 35 contact or slide in contact with the contact portions 18A, whereby the locking of the lock protrusions 35 and the lock receiving portions 18 is hardly released. Thus, a movement of the connection detecting member 30 to the complete locking position can be further suppressed in the state where the connector 10 is not properly connected.

### Other Embodiments

(1) Although the pair of locking pieces 33 include the first locking projections 33A and the second locking projections 33B and the pair of side wall portions 20 include the third locking projections 20A and the fourth locking projections 20B in the above embodiment, there is no limitation to this. For example, first and second locking projections may be provided on both side parts of a body portion and third and fourth locking projections may be provided on a pair of protective walls. Further, the plurality of locking structures between the connection detecting member 30 and the housing 11 may have configurations other than the above ones.

(2) Although the lock receiving portion 18 includes the contact portion 18A and the ceiling portion 18B in the above embodiment, there is no limitation to this and a lock receiving portion may include only a contact portion.

### LIST OF REFERENCE NUMERALS

10: connector
11: housing
12: cavity
13: outer peripheral wall
14: lock arm
14A: front half
15: lock portion
15A: lock recess
16: arm portion
16A: facing surface
17: operating portion
18: lock receiving portion
18A: contact portion
18B: ceiling portion
19: protective wall
20: side wall portion
20A: third locking projection
20B: fourth locking projection
21: coupling portion
30: connection detecting member
31: body portion
32: detection arm
33: locking piece
33A: first locking projection
33B: second locking projection
34: stopper
35: lock protrusion
35A: first surface
35B: second surface
35C: third surface
36: projecting portion
36A: inclined surface
37: projection
50: mating connector
51: mating housing
52: mating lock portion

1. A connector, comprising:
a housing connectable to a mating housing; and
a connection detecting member movable between a temporary locking position and a complete locking position with respect to the housing, the connection detecting member being allowed to move from the temporary locking position to the complete locking position with the housing and the mating housing properly connected,
the housing including a lock arm cantilevered from an outer peripheral wall of the housing, the lock arm being formed to be deflectable and deformable,
the lock arm including a lock portion lockable to the mating housing, a pair of arm portions disposed on both sides of the lock portion, the pair of arm portions extending from the lock portion to a free end side of the lock arm, and an operating portion coupling the pair of arm portions,
each of the pair of arm portions including a lock receiving portion,
the connection detecting member including a body portion and a detection arm extending from the body portion,
the detection arm including a stopper disposed on a tip part of the detection arm and two lock protrusions disposed on both sides of the stopper, and
a movement of the connection detecting member from the temporary locking position to the complete locking position being suppressed by locking the stopper to the lock portion and locking the lock protrusions to the lock receiving portions.

2. The connector according to claim 1, wherein:
the lock receiving portion includes a contact portion and a ceiling portion connected to the contact portion, the ceiling portion being formed in a range from the contact portion to the operating portion in a connection direction of the housing and the mating housing,
the complete locking position is located on one side in the connection direction with respect to the temporary locking position, and
the ceiling portion is facing the lock protrusion in a deflection direction of the lock arm orthogonal to the connection direction and the contact portion is disposed to be lockable to the lock protrusion in the connection direction when the connection detecting member is pushed to the one side in the connection direction with the connection detecting member located at the temporary locking position.

3. The connector according to claim 2, wherein the contact portion is inclined in a direction separating from the outer peripheral wall with respect to the deflection direction toward the one side in the connection direction.
